(19) United States
(12) Patent Application Publication
(10) Pub. No.: US 2025/0004117 A1
(43) Pub. Date: Jan. 2, 2025

(54) METHOD AND SYSTEM FOR MEASURING VELOCITY BASED ON WIRELESS COMMUNICATION, STORAGE MEDIUM, AND DEVICE

(71) Applicants: Suzhou Yihete Communication Technology Co., Ltd., Suzhou (CN); Deke Innovation (Shenzhen) Technology Co., Ltd., Shenzhen (CN)

(72) Inventor: Keke ZU, Shenzhen (CN)

(73) Assignees: Suzhou Yihete Communication Technology Co., Ltd., Suzhou (CN); Deke Innovation (Shenzhen) Technology Co., Ltd., Shenzhen (CN)

(21) Appl. No.: 18/750,752

(22) Filed: Jun. 21, 2024

(30) Foreign Application Priority Data
Jun. 29, 2023 (CN) 202310787663.1

(51) Int. Cl. G01S 11/10; G01S 11/02; G01S 11/04

(52) U.S. Cl. CPC G01S 11/10; G01S 11/026; G01S 11/04

(57) ABSTRACT

Disclosed are a method and a system for measuring a velocity based on wireless communication, a storage medium and a device. The method includes: obtaining a first observation signal and a second observation signal; obtaining a first channel estimate and a second channel estimate according to the first and second observation signals; obtaining a first path gain and a second path gain based on the first channel estimate and the second channel estimate; obtaining a path phase difference according to the first path gain and the second path gain; and obtaining a Doppler shift based on the path phase difference and the preset duration, and obtaining a moving velocity of the transmitting device relative to the receiving device based on the Doppler shift.

### CROSS-REFERENCE TO RELATED APPLICATIONS

This application claims priority to Chinese Patent Application NO. 202310787663.1, filed on Jun. 29, 2023, the entire contents of which are incorporated herein by reference.

### TECHNICAL FIELD

The present application relates to the technical field of wireless communication, and in particular to a method and a system for measuring a velocity based on wireless communication, a storage medium and a device.

### BACKGROUND

Sensing devices represented by a radar can measure the position, velocity and orientation of moving targets. The principle for measuring the velocity by the radar is to detect the Doppler shift caused by the movement of objects, and to calculate the velocity of a moving target from the obtained Doppler shift.

However, with the development of wireless technology, the size of mobile terminals has become smaller and lighter. If the radar module and the wireless communication module are to be integrated on the mobile terminal to realize the velocity measurement function, not only the manufacturing cost of the mobile terminal will be high, but also it would be challenging to optimally utilize both radar and communication functions simultaneously, achieving the maximum resource utilization rate.

### SUMMARY

Based on this, it is necessary to provide a method and a system for measuring a velocity based on wireless communication, a storage medium and a device to address the above problems.

The present application provides a method for measuring a velocity based on wireless communication, applied to a communication system, the communication system including a transmitting device and a receiving device communicated with the transmitting device, and the transmitting device being configured to transmit a first reference signal and a second reference signal to the receiving device at an interval of a preset duration;
the method for measuring the velocity based on wireless communication including:
obtaining a first observation signal and a second observation signal, the first observation signal and the second observation signal are signals actually received by the receiving device when the first reference signal and the second reference signal are transmitted to the receiving device via a channel;
obtaining a first channel estimate and a second channel estimate according to the first observation signal and the second observation signal respectively;
obtaining a first path gain corresponding to the first reference signal and a second path gain corresponding to the second reference signal based on the first channel estimate and the second channel estimate respectively;
obtaining a path phase difference experienced by the first reference signal and the second reference signal when transmitted to the receiving device according to the first path gain and the second path gain; and
obtaining a Doppler shift based on the path phase difference and the preset duration, and obtaining a moving velocity of the transmitting device relative to the receiving device based on the Doppler shift.

In an embodiment, obtaining the first channel estimate and the second channel estimate according to the first observation signal and the second observation signal includes:
multiplying the first observation signal and the second observation signal by a conjugate transpose or inverse of the first reference signal and the second reference signal respectively to obtain the first channel estimate and the second channel estimate.

In an embodiment, obtaining the first path gain corresponding to the first reference signal and the second path gain corresponding to the second reference signal based on the first channel estimate and the second channel estimate respectively includes:
obtaining a first steering vector matrix corresponding to the first reference signal and a second steering vector matrix corresponding to the second reference signal respectively;
obtaining the first path gain based on the first steering vector matrix and the first channel estimate; and
obtaining the second path gain based on the second steering vector matrix and the second channel estimate.

In an embodiment, obtaining the first steering vector matrix corresponding to the first reference signal and the second steering vector matrix corresponding to the second reference signal includes:
obtaining a first angle of arrival corresponding to the first reference signal and a second angle of arrival corresponding to the second reference signal through measurement, and obtaining the first steering vector matrix and the second steering vector matrix based on the first angle of arrival and the second angle of arrival respectively; or
obtaining the first steering vector matrix corresponding to the first reference signal and the second steering vector matrix corresponding to the second reference signal directly through measurement; or
extracting peak index through the first channel estimate to obtain a first position of the peak, obtaining a first beam arrival direction according to the first peak position, and obtaining the first steering vector matrix according to the first beam arrival direction; and extracting peak index through the second channel estimate to obtain a second position of the peak, obtaining a second beam arrival direction according to the second peak position, and obtaining the second steering vector matrix according to the second beam arrival direction; or reporting, via the transmitting device, a position to a receiving end actively to obtain the first angle of arrival corresponding to the first reference signal and the second angle of arrival corresponding to the second reference signal; obtaining the first steering vector matrix and the second steering vector matrix respectively based on the first angle of arrival and the second angle of arrival; or
reporting, via the transmitting device, the first steering vector matrix corresponding to the first reference signal and the second steering vector matrix corresponding to the second reference signal to the receiving end actively.

In an embodiment, obtaining the first steering vector matrix corresponding to the first reference signal and the second steering vector matrix corresponding to the second reference signal respectively includes:
configuring the first steering vector matrix as the second steering vector matrix; or
configuring the second steering vector matrix as the first steering vector matrix.

In an embodiment, obtaining the path phase difference experienced by the first reference signal and the second reference signal according to the first path gain and the second path gain includes:
calculating a cross-correlation function according to the first path gain and the second path gain, and extracting the path phase difference from the cross-correlation function.

In an embodiment, obtaining the first channel estimate and the second channel estimate according to the first observation signal and the second observation signal respectively includes:
obtaining the first channel estimate and the second channel estimate according to any one of least square channel estimate, linear minimum mean square error channel estimate, singular value decomposition-based channel estimate, Fourier transform-based channel estimate, and artificial intelligence-based channel estimate.

In an embodiment, the first reference signal and the second reference signal are signals whose transmission time and/or content is agreed upon by the transmitting device and the receiving device in advance;
the first reference signal and the second reference signal include any one or two of a demodulation reference signal, a sounding reference signal, a channel state information reference signal, a phase tracking reference signal, a synchronization signal, and a positioning reference signal; or
the first reference signal and the second reference signal include any one or two of a cyclic prefix signal, a broadcast signal, and a beacon signal; or
the first reference signal and the second reference signal include any one or two of a short training sequence signal and a long training sequence signal.

The present application also provides a system for measuring a velocity based on wireless communication, including:
a transmitting device and a receiving device communicated with the transmitting device;
the transmitting device is configured to transmit a first reference signal and a second reference signal to the receiving device at an interval of a preset duration;
the receiving device is configured to obtain a first observation signal and a second observation signal, obtain a first channel estimate and a second channel estimate according to the first observation signal and the second observation signal respectively, obtain a first path gain corresponding to the first reference signal and a second path gain corresponding to the second reference signal based on the first channel estimate and the second channel estimate respectively, obtain a path phase difference experienced by the first reference signal and the second reference signal when transmitted to the receiving device according to the first path gain and the second path gain, obtain a Doppler shift based on the path phase difference and the preset duration, and obtain a moving velocity of the transmitting device relative to the receiving device based on the Doppler shift; and
the first observation signal and the second observation signal are signals actually received by the receiving device when the first reference signal and the second reference signal transmitted to the receiving device via a channel.

The present application also provides a computer device, including a memory and a processor, a computer program is stored in the memory, and when the computer program is executed by the processor, the processor is caused to perform the method for measuring the velocity based on wireless communication as described above.

The present application also provides a computer-readable storage medium, a computer program is stored in the computer-readable storage medium, and when the computer program is executed by a processor, the processor is caused to perform the method for measuring the velocity based on wireless communication as described above.

The embodiments of the present application have the following beneficial effects.

By receiving and transmitting the first reference signal and the second reference signal sent at a preset duration, the path gain and phase difference of the first reference signal and the second reference signal are obtained. Since the preset duration is known, the Doppler shift can be calculated based on the phase difference and the preset duration. Based on the Doppler shift, the moving velocity of the transmitting device relative to the receiving device can be obtained. This realizes the measurement of the moving velocity of devices in the wireless communication system. With the help of the existing reference signal and channel estimation function of the communication system, the communication system realizes the velocity measurement of mobile objects without changing the existing communication waveform, frame structure, hardware architecture, etc., which eliminates the need to provide special sensing devices such as radar, maximizes the utilization of resources, and reduces the manufacturing cost of communication systems.

### BRIEF DESCRIPTION OF THE DRAWINGS

In order to explain the technical solutions in the embodiments of the present application or the related art more clearly, accompanying drawings needed to be used in the description of the embodiments or the related art will be briefly introduced below. Obviously, the drawings in the following description are only some embodiments of the present application. For those skilled in the art, other drawings can be obtained based on these drawings without creative efforts.

FIG. 1 is a schematic flow chart of a method for measuring a velocity based on wireless communication according to a first embodiment of the present application.

FIG. 2 is a schematic structural diagram of a communication system according to an embodiment of the present application.

FIG. 3 is a structural block diagram of a computer device in an embodiment.

### DETAILED DESCRIPTION OF THE EMBODIMENTS

The technical solutions in the embodiments of the present application will be clearly and completely described below with reference to the accompanying drawings. Obviously, the described embodiments are only some, not all, of the embodiments of the present application. Based on the embodiments of the present application, all other embodiments obtained by those skilled in the art without creative efforts fall within the scope of the present application.

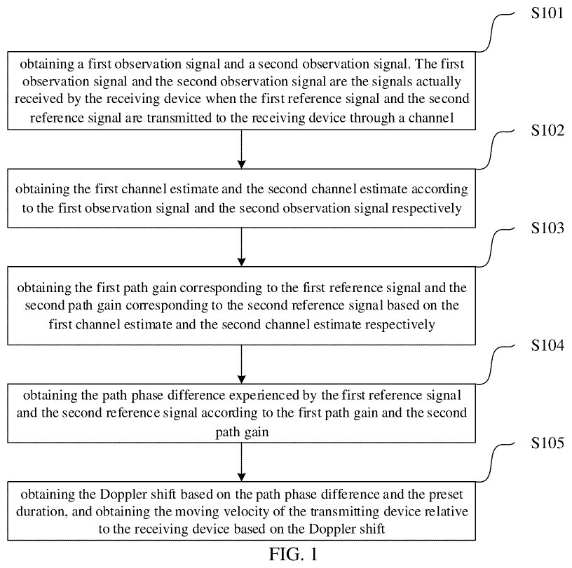

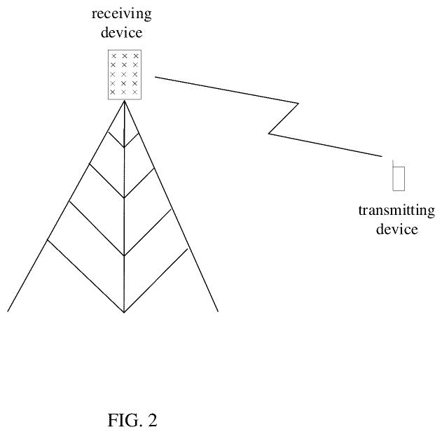

Please refer to FIG. 1, which is a schematic flowchart of a method for measuring a velocity based on wireless communication according to a first embodiment of the present application. The method for measuring a velocity based on wireless communication provided by the present application is applied to a communication system. Please refer to FIG. 2, which is a schematic structural diagram of a communication system according to an embodiment of the present application. The communication system includes a transmitting device and a receiving device that communicate with each other. One of the transmitting device and the receiving device is a communication base station and the other is a mobile terminal. The transmitting device can transmit a first reference signal and a second reference signal to the receiving device at intervals of a preset duration Δₜ, and the second reference signal is sent after the first reference signal is sent.

The method for measuring the velocity based on wireless communication provided by the present application includes the following steps:

S101, obtaining a first observation signal and a second observation signal. The first observation signal and the second observation signal are the signals actually received by the receiving device when the first reference signal and the second reference signal are transmitted to the receiving device through a channel.

In a specific implementation scenario, after the first reference signal and the second reference signal are transmitted by the transmitting device, they are transmitted to the receiving device via the channel. During the transmission via the channel, they will be affected by channel fading, so the signals actually received by the receiving device are the first observation signal and the second observation signal generated by the first reference signal and the second reference signal.

The signal transmission time and/or content of the first reference signal and the second reference signal can be predefined, and both the transmitting device and the receiving device know the transmission time and/or content. Further, the first reference signal and the second reference signal can be orthogonal signals. The main feature of the orthogonal signals is that they are independent of each other in an orthogonal direction. That is to say, there is no mutual interference between them, which can ensure accuracy of the received signal and avoid subsequent calculation errors due to signal interference. The Zadoff-Chu sequence is commonly used in wireless communication systems to implement the first reference signal and the second reference signal. The q-th sequence of the Zadoff-Chu sequence set with a length of NZC can be expressed as:

$${x}_{t} = {e}^{j π q \frac{p ( p + 1 )}{{N}_{ZC}}} , 0 \leq p \leq {N}_{Z C} \qquad ( 1 )$$

In an implementation scenario, the first reference signal and the second reference signal are signals agreed in advance by the transmitting device and the receiving device. For example, the transmitting device and the receiving device agree to use a demodulation reference signal (DMRS) as the first reference signal and the second reference signal.

In another implementation scenario, the first reference signal and the second reference signal can be signals of the same type or signals of different types. For example, when the communication system is a communication system defined by the 3GPP protocol standard, the first reference signal and the second reference signal can be any one or two of DMRS, sounding reference signal (SRS), channel state information reference signal (CSI-RS), phase tracking reference signal (PT-RS), synchronization signal (SS) and positioning reference signal (PRS). For another example, when the communication system is a communication system defined by the WiFi protocol standard, the first reference signal and the second reference signal can be any one or two of a short training field (STF) signal or a long training field (LTF) signal.

In another implementation scenario, the first reference signal and the second reference signal can be non-orthogonal signals, as long as they are pre-designed signals that are known to both the receiving device and the transmitting device.

In another implementation scenario, the first reference signal and the second reference signal can be known to the transmitting device, and fed back to the receiving device through signaling by the transmitting device.

In another implementation scenario, the first reference signal and the second reference signal can be measured and obtained by the receiving device.

In another implementation scenario, the preset duration Δₜ for transmitting the first reference signal and the second reference signal can be known to the transmitting device, and fed back to the receiving device through signaling by the transmitting device.

In another implementation scenario, the preset duration Δₜ for transmitting the first reference signal and the second reference signal can be obtained by the receiving device through measurement.

S102, obtaining the first channel estimate and the second channel estimate according to the first observation signal and the second observation signal respectively.

In a specific implementation scenario, the receiving device estimates the first channel estimate according to the received first observation signal and the first reference signal, and estimates the second channel estimate using the same method. The first channel estimate is an estimate of the wireless channel for transmitting the first reference signal and obtained from the received first observation signal. Here, the case where the first reference signal and the second reference signal are DMRS is taken as an example for description. Because the DMRS signal satisfies orthogonality, the first observation signal received by the receiving device is multiplied by the conjugate transpose of the first reference signal to eliminate the influence of the first reference signal and obtain channel observation items H_{LS} containing noise.

In wireless communications, signals pass through multiple paths when transmitted from the transmitting device to the receiving device, and the signals on each path are subject to different attenuation and phase changes. The wireless channel matrix describes the impact of these paths on the signal. The wireless channel matrix can be expressed as a combination of path gain and steering vector, where the path gain represents the attenuation degree of the signal on each path, and the steering vector represents the phase delay of the signal in each antenna unit of the array antenna. The steering vector is determined by the position of each antenna element of the array antenna, the carrier frequency and the arrival direction of the incident wave. For a given wireless communication system, the first two are usually known, for example, the spacing between antenna units is half a wavelength and the frequency is 5 GHz. The arrival direction of the incident wave used to describe the steering vector can be obtained from the angle of arrival (AOA). The AOA refers to the direction angle at which the signal reaches the receiving antenna, and is usually used to describe the signal transmission direction in the wireless channel.

Taking a uniform linear array (ULA) base station equipped with M antenna units as an example, the wireless channel matrix between the ULA base station and single-antenna users can be expressed as:

$$h = \sqrt{\frac{M}{P + 1}} {Σ}_{p = 0}^{P} {a}_{p} S ( {θ}_{p} ) \qquad ( 2 )$$

Where a₀S(θ₀) is the line-of-sight (LOS) path component. As the name suggests, the line-of-sight path refers to the direct path between the signal from the transmitting antenna to the receiving antenna in wireless communication. Because it is not affected by multipath fading, the line-of-sight path is usually one of the strongest signal components in multiple paths.

a₀ is the path gain of the direct path, aₚ component corresponding to 1≤p≤P is the non-line-of-sight path component, P is the total multipath number, and θₚ is the arrival angle of the path p.

S(θₚ) is the steering vector of the antenna, its elements can be expressed as:

$$S ( {θ}_{p} ) = [ {e}^{- j 2 π \frac{d}{λ} s i n {θ}_{p} m} ] \qquad ( 3 )$$

Where

$$m ∈ [ q - \frac{( M - 1 )}{2} , q = 0 , 1 , … , M - 1 ] ,$$

is the wavelength of the signal carrier, and d is the spacing between antenna units, usually d=λ/2 in the wireless communication system.

For the communication system shown in FIG. 2, the number of antenna units equipped by the base station is M, the number of antenna units equipped by the mobile terminal is N, and the number of transmission streams is S, then the wireless channel matrix of the uplink channel can be expressed as H∈C^{MXS}, where C represents the complex domain.

Assume that the mobile terminal is the transmitting device and the base station is the receiving device. The first reference signal sent by the mobile terminal to the base station is xₜ∈ C^{sx1} and is sent by the mobile terminal at time t. The observation signal yₜ containing the first reference signal received at the base station side is expressed as:

$${y}_{t} = {H}_{t} {x}_{t} + n \qquad ( 4 )$$

Where n∈C^{MX1} represents noise.

Since the mobile terminal are basically powered by batteries, and the power consumption and computing power provided by batteries are relatively limited, in practice, the mobile terminal is usually equipped with a single antenna, so N=S=1.

Because the reference signal xₜ is known to the receiving device, the least square (LS) channel estimate can be expressed as:

$${H}_{L S} = {y}_{t} {x}_{t}^{- 1} \qquad ( 5 )$$

Therefore, in this implementation scenario, the least square channel estimate H_{LS} can be calculated according to the first observation signal (yₜ) received by the receiving device and the first reference signal (xₜ) transmitted by the transmitting device. That is to say, the first channel estimate can be calculated by multiplying the received first observation signal (yₜ) by its corresponding transmitted signal, that is, the inverse of the first reference signal (xₜ). When the reference signal satisfies orthogonality, the inversion operation can be replaced by a simple conjugate transpose.

Because least square channel estimate is simple to implement, it has been widely used in the industry. However, its shortcomings are also obvious. Since the influence of the noise term is not considered, when the channel condition is not good, the noise will be greatly amplified, causing channel estimate performance to drop significantly. Therefore, linear minimum mean squared error (LMMSE) channel estimate is often used to improve LS channel estimate.

$${H}_{LMMSE} = {{R}_{HH} ( {R}_{HH} + \frac{β}{SNR} )}^{- 1} {H}_{LS} \qquad ( 6 )$$

Where R_{HH}=E{HH^{H}} is the autocorrelation matrix of the channel signal, β is a constant determined by the constellation point of the transmitted signal (for example, for 16-QAM, β=17/9), and SNR represents the signal-to-noise ratio.

The steps of obtaining the second channel estimate according to the second observation signal are the same as the steps of obtaining the first channel estimate according to the first observation signal, and will not be described again here.

In another implementation scenario, LMMSE can be used instead of LS channel estimate to obtain the first channel estimate value and the second channel estimate value. LMMSE can greatly improve channel estimate performance, but its calculation and implementation complexity also greatly increases. In order to reduce the computational complexity of LMMSE channel estimate, researchers use the time domain sparsity of wireless signals to approximate LMMSE. For example, they can only consider the first L (1<L<N) elements of R_{HH}. In the cross-correlation matrix R_{HH}, only the first L elements are retained, and other elements are set to zero, thereby reducing the computational complexity of LMMSE.

In another implementation scenario, the first channel estimate and the second channel estimate can also be obtained through a channel estimate algorithm based on Fourier transform. Fourier Transform is a signal processing technology that can convert time domain signals into frequency domain or spatial angle domain signals. The channel estimate method based on Fourier transform is a commonly used channel estimate method and is mainly used in orthogonal frequency division multiplexing (OFDM) system.

The basic idea of channel estimate based on Fourier transform is to use fast Fourier transform to convert the received first observation signal and/or second observation signal (such as the received observation signal yₜ of formula (4) or the channel observation item H_{LS} of formula (5)) into the spatial angle domain (also called the beam domain), find the beam direction containing the main energy, set the beam in other directions to zero, and then transform the zeroed channel back through the inverse Fourier transform, thereby achieving rapid estimation and reconstruction of wireless channels.

In another implementation scenario, the first channel estimate and the second channel estimate can also be obtained through a channel estimate algorithm based on singular value decomposition. The singular value decomposition (SVD) is a commonly used matrix decomposition method that can decompose a matrix into the product of three matrices, namely the left singular vector matrix, the singular value matrix and the right singular vector matrix. In the wireless communication, SVD is a commonly used linear algebra tool that can decompose a complex matrix into the product form of three simple matrices, namely:

$$A = U \sum {V}^{H}$$

Where U and V are orthogonal unitary matrices and E is a diagonal matrix.

The time domain sparseness of the signal is also reflected in the eigenvalue space. The SVD eigenvalue decomposition of R_{HH} is R_{HH}=UΣU^{H}, and only the eigenvalue vector with rank p is retained, thus obtaining the low-rank channel estimate as:

$${\hat{h}}_{LowRank} = U {Δ}_{p} {U}^{H} {\hat{h}}_{L S} \qquad ( 7 )$$

Where Δ_{P} is a diagonal matrix, the first p diagonal elements δₖ=λₖ/(λₖ+3/SNR) (λₖ is the eigenvalue of R_{HH}), and the elements at other positions are zero.

In another implementation scenario, the first channel estimate and the second channel estimate can also be obtained through a channel estimate method based on artificial intelligence. As commercial wireless communication systems expand from the traditional unitary linear array (ULA) to the unitary planar array (UPA), the channel matrix expands from one-dimensional vectors to multi-dimensional tensors, and the channel signals of large-scale antenna arrays have sparsity in dimensions such as time-frequency-space, etc., which gives the channel signal properties similar to image signals. The wireless channel signals are actually a type of images, so we call them channel images. This has inspired researchers to apply deep learning network based on convolutional neural network (CNN) that have achieved excellent performance in the field of image processing to channel estimate.

The application of deep learning in channel estimate can be roughly divided into two categories, one is model-driven and the other is data-driven. Model-driven systems are based on predefined mathematical models and their optimization, while data-driven systems are based on data and its learning. The model-driven method assumes that the randomness of the wireless channel follows a certain mathematical distribution, and uses deep learning to learn and estimate the parameters of this model. In contrast, data-driven methods do not rely on mathematical models of wireless channel distribution and expert knowledge. Instead, they use collected channel data to train neural networks to learn, extract, and identify features of the wireless channel.

Channel estimate based on artificial intelligence can also regard the channel as a discrete time series, and estimate and predict the channel through a long short term memory (LSTM) network based on recurrent neural network (RNN).

S103, obtaining the first path gain corresponding to the first reference signal and the second path gain corresponding to the second reference signal based on the first channel estimate and the second channel estimate respectively.

In a specific implementation scenario, the first path gain corresponding to the first reference signal is obtained based on the first channel estimate. For example, the first channel estimate obtained according to the above formulas (2) to (5) is the LS channel estimate or LMMSE channel estimate, and the steering vector S(θₚ) corresponding to the LS channel estimate or the LMMSE channel estimate can be obtained. The first path gain can be obtained according to the first channel estimate and its corresponding steering vector. The second steering vector matrix and the second path gain can be obtained using the same method.

In other implementation scenarios, the peak index is extracted through the first channel estimate, the beam arrival direction and angle are obtained according to the location of the peak, and the first steering vector matrix is obtained. In the wireless communication system of massive antenna array (Massive MIMO), due to the large number of antennas, the channel shows strong sparsity in the spatial angle domain. This means that from a spatial perspective, the channel has only a few main paths, and the signal attenuation of other paths is very deep and can be ignored. Through the first channel estimate, we can obtain the peak index of the multipath channel in the spatial angle domain, that is, determine the path directions in which the signal is transmitted. The positions of these peak points correspond to the main transmission direction of the signal in spatial perspective. Therefore, we can process these peaks to obtain the arrival direction of each path to reconstruct the steering vector matrix, and thus obtain the first steering vector matrix corresponding to the first channel estimate. Specifically, we can sort the peaks according to energy, extract the position of the first peak, subtract the impact of the first peak on other paths, then extract the position of the second peak from the remaining peaks, and then subtract the impact of the second peak on other paths, and so on, until the peaks containing the main energy of the channel are extracted. Similarly, the second steering vector matrix is obtained according to the obtained second channel estimate.

The first path gain is calculated according to the first steering vector and the first channel estimate:

$${A}_{DMSR 1} = ( {( {S}_{1}^{H} {S}_{1} )}^{- 1} {S}_{1}^{H} ) {H}_{L S 1} \qquad ( 8 )$$

Where A_{DMSR1} is the first path gain, H_{LS1} is the first channel estimate, and S₁ is the first steering vector.

The second path gain is calculated according to the second steering vector and the second channel estimate:

$${A}_{DMSR 2} = ( {( {S}_{2}^{H} {S}_{2} )}^{- 1} {S}_{2}^{H} ) {H}_{L S 2} \qquad ( 9 )$$

Where A_{DMSR2} is the second path gain, H_{LS2} is the second channel estimate, and S₂ is the second steering vector.

In another implementation scenario, the first angle of arrival corresponding to the first reference signal can be obtained through a measurement method. The measurement technology of angle of arrival is a classic and mature technology. In the wireless communication system, antenna arrays or antenna combinations can be used to measure the angle of arrival. The antenna array is an array composed of multiple antennas, and the first angle of arrival for receiving the first reference signal can be determined by performing a weighted sum of received signals of different antennas. The antenna combination combines signals from multiple antennas and determines the first angle of arrival corresponding to the first reference signal by analyzing the combined signals. In addition, signal processing technology can also be used to extract the first angle of arrival corresponding to the first reference signal. For example, by performing beam forming or spatial filtering on the received signal, the first angle of arrival corresponding to the first reference signal can be extracted.

The measured first angle of arrival corresponding to the first reference signal is described as θ₁, based on θ₁, the first steering vector S₁ is obtained. Similarly, the second angle of arrival θ₂ and the second steering vector S₂ corresponding to the second reference signal are obtained. Based on the first channel estimate and the first steering vector obtained in the above steps, the first path gain corresponding to the transmission of the first reference signal to the receiving device can be obtained. The second path gain can be obtained in the same way.

In another implementation scenario, based on the fact that the steering vector has slowly changing characteristics in the spatial domain, it can be considered that the steering vector changes very slowly in adjacent time and space positions. Therefore, the steering vector of the current signal can be approximately obtained by measuring the steering vector of the adjacent reference signal. It is considered that the first steering vector and the second steering vector corresponding to the first reference signal and the second reference signal are approximately the same, the first steering vector is also used as the second steering vector, and both the first steering vector and the second steering vector are denoted by S₀. In other implementation scenarios, the second steering vector can also be obtained, and the second steering vector can also be used as the first steering vector. The method steps remain unchanged and will not be described again here. Then the first path gain and the second path gain are respectively:

$${A}_{DMSR 1} = ( {( {S}_{0}^{H} {S}_{0} )}^{- 1} {S}_{0}^{H} ) {H}_{L S 1} \qquad ( 10 )$$

$${A}_{DMSR 2} = ( {( {S}_{0}^{H} {S}_{0} )}^{- 1} {S}_{0}^{H} ) {H}_{L S 2} \qquad ( 11 )$$

S104, obtaining the path phase difference experienced by the first reference signal and the second reference signal according to the first path gain and the second path gain.

In a specific implementation scenario, the cross-correlation coefficient of the first observation signal and the second observation signal is obtained according to the first path gain and the second path gain:

$${R}_{DMRS} = conj ( {A}_{DMSR 1} ) {A}_{DMSR 2} = exp ( j 2 πΔ {tf}_{d} ) \qquad ( 12 )$$

Where, conj ( ) is the conjugate operation, Δt is the preset duration when the first reference signal and the second reference signal are sent, and f_{d} is the Doppler shift.

The preset duration Δt is usually the interval known by both the transmitter and the receiver. Or the time interval Δt can be known to the transmitting device and fed back to the receiving end through signaling. Or the time interval Δt can be obtained through measurement by the receiving end.

According to the correlation coefficient R_{DMRS}, the path phase difference Ω between the first observation signal and the second observation signal can be obtained by combining the following formula (13):

$${R}_{DMRS} = exp ( j Ω ) \qquad ( 13 )$$

S105, obtaining the Doppler shift based on the path phase difference and the preset duration, and obtaining the moving velocity of the transmitting device relative to the receiving device based on the Doppler shift.

In a specific implementation scenario, the Doppler shift can be calculated according to the following formula (14):

$${f}_{d} = Ω / ( 2 πΔ t ) \qquad ( 14 )$$

Doppler shift is caused by the movement of the transmitting device (in this implementation scenario, the mobile terminal) relative to the receiving device (in this implementation scenario, the base station), that is, the movement of the user. Therefore:

$${f}_{d} = ( v / λ ) cos ( θ ) \qquad ( 15 )$$

Where v is the moving velocity of the transmitting device (in this implementation scenario, the mobile terminal) relative to the receiving device (in this implementation scenario, the base station), and θ is the angle between the receiving device and the transmitting device, which can be obtained through the first angle of arrival or the second angle of arrival obtained by the first channel estimate or the second channel estimate, or obtained through measurement. λ is the carrier wavelength of the first reference signal or the second reference signal transmitted by the transmitting device.

Combining formulas (14) and (15), the moving velocity v of the transmitting device relative to the receiving device can be obtained:

$$v = ( Ω λ ) / ( 2 πΔ t cos ( θ ) ) \qquad ( 16 )$$

In other implementation scenarios, the base station can also be used as the transmitting device and the mobile terminal can be used as the receiving device. The principles are roughly the same and will not be described again here.

It should be noted that although traditional radar velocity measurement also uses the Doppler effect to measure the velocity of moving targets, it is completely different from the technical features of the present application. Radar velocity measurement relies on detecting the echo of the transmitted signal. From the deviation of the echo frequency and the original transmission frequency, the Doppler shift is obtained, and then the moving velocity v is calculated. The signal waveform of the first reference signal and the second reference signal used in the wireless communication system of the present application are sine and cosine waveform, which are periodic waveform, therefore, it is not suitable to be used to extract the Doppler shift between the echo and the transmitted wave, which means that solutions and technologies of the radar velocity measurement cannot work properly in wireless communication scenarios.

As can be seen from the above description, in this embodiment, the path gain and phase difference of the first reference signal and the second reference signal are obtained by receiving the first reference signal and the second reference signal sent with a preset duration Δₜ. Since the preset duration Δₜ is known to both communicating parties in the communication system, the Doppler shift can be calculated based on the phase difference and the preset duration Δₜ for transmitting the reference signal. Based on the Doppler shift, the moving velocity of the transmitting device relative to the receiving device can be obtained. The present application realizes the measurement of the moving velocity of devices in the wireless communication system. With the help of the existing reference signal and channel estimate function of the communication system, the communication system realizes the velocity measurement of the moving objects without changing the existing communication waveform, frame structure, hardware architecture, etc., thereby eliminating the need to equip special sensing equipment such as radar and reducing the cost of velocity measurement.

The present application can realize velocity measurement based on wireless communication signals, and thus can be used in many fields, such as vehicle navigation, traffic monitoring, etc. At the same time, the present application can obtain the Doppler shift by transmitting the reference signal with known preset duration, thereby calculating the moving velocity, which has the advantages of high accuracy and fast computation seed.

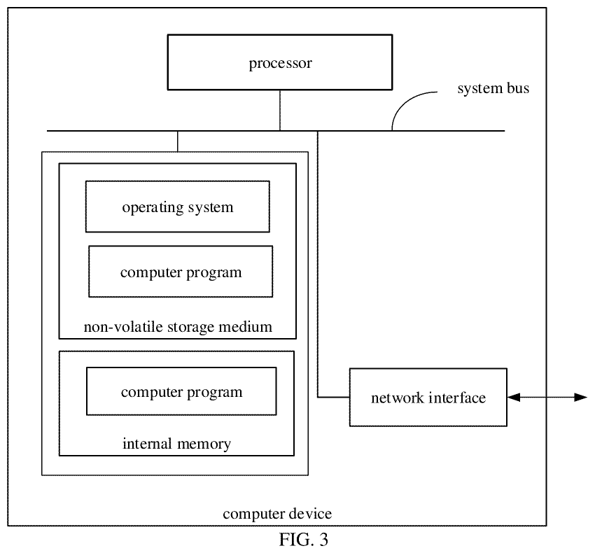

FIG. 3 shows an internal structure diagram of a computer device in an embodiment. Specifically, the computer device can be a terminal or a server. As shown in FIG. 3, the computer device includes a processor, a memory and a network interface connected through a system bus. The memory includes non-volatile storage medium and internal memory. The non-volatile storage medium of the computer device stores an operating system and can also store a computer program. When the computer program is executed by the processor, the processor can implement the communication velocity measurement method. The computer program can also be stored in the internal memory. When the computer program is executed by the processor, the processor can perform the communication velocity measurement method. Those skilled in the art can understand that the structure shown in FIG. 3 is only a block diagram of a partial structure related to the solution of the present application, and does not constitute a limitation on the computer device to which the solution of the present application is applied. The specific computer device can include more or fewer parts than shown, or combinations of certain parts, or differently arranged parts.

In an embodiment, a computer device is proposed, including a memory and a processor. A computer program is stored in the memory. When the computer program is executed by the processor, the processor is caused to perform the above steps.

In an embodiment, a computer-readable storage medium is proposed, a computer program is stored in the computer-readable storage medium. When the computer program is executed by a processor, the processor is caused to perform the above steps.

Distinct from the existing technologies, the present application solves the problem that the target velocity cannot be measured by the wireless communication systems, and proposes a new and effective communication velocity measurement technology. With the help of the existing reference signal and channel estimate module of the communication system, the communication system realizes the velocity measurement of the moving objects without changing the existing communication waveform, frame structure, hardware architecture, etc., thereby eliminating the need to equip special sensing equipment such as radar, achieving the maximum utilization of resources and reducing the manufacturing cost of the communication system

Those skilled in the art can understand that all or part of the processes in the methods of the above embodiments can be implemented by instructing relevant hardware through computer programs. The programs can be stored in a non-volatile computer-readable storage medium. When the program is executed, the processes of the above-mentioned method embodiments can be included. Any reference to memory, storage, database or other media used in the embodiments of the present application can include non-volatile and/or volatile memory. The non-volatile memory can include read-only memory (ROM), programmable ROM (PROM), electrically programmable ROM (EPROM), electrically erasable programmable ROM (EEPROM), or flash memory. The volatile memory can include random access memory (RAM) or external cache memory. By way of illustration and not limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous chain DRAM (SLDRAM), memory bus (Rambus) direct RAM (RDRAM), direct memory bus dynamic RAM (DRDRAM), and memory bus dynamic RAM (RDRAM), etc.

The technical features of the above embodiments can be combined in any way. To simplify the description, not all possible combinations of the technical features in the above embodiments are described. However, as long as there is no contradiction in the combination of these technical features, they should be considered to be within the scope of the present application.

The above-described embodiments only express several implementation modes of the present application, and their descriptions are relatively specific and detailed, but should not be construed as limiting the scope of the present application. It should be noted that, for those skilled in the art, several modifications and improvements can be made without departing from the concept of the present application, and these all fall within the scope of the present application. Therefore, the scope of the present application shall be determined by the appended claims.

What is claimed is:

1. A method for measuring a velocity based on wireless communication, applied to a communication system, the communication system comprising a transmitting device and a receiving device communicated with the transmitting device, and the transmitting device being configured to transmit a first reference signal and a second reference signal to the receiving device at an interval of a preset duration; the method for measuring the velocity based on wireless communication comprising:
obtaining a first observation signal and a second observation signal, wherein the first observation signal and the second observation signal are signals actually received by the receiving device when the first reference signal and the second reference signal are transmitted to the receiving device via a channel;
obtaining a first channel estimate and a second channel estimate according to the first observation signal and the second observation signal respectively;
obtaining a first path gain corresponding to the first reference signal and a second path gain corresponding to the second reference signal based on the first channel estimate and the second channel estimate respectively;
obtaining a path phase difference experienced by the first reference signal and the second reference signal when transmitted to the receiving device according to the first path gain and the second path gain; and
obtaining a Doppler shift based on the path phase difference and the preset duration, and obtaining a moving velocity of the transmitting device relative to the receiving device based on the Doppler shift.

2. The method for measuring the velocity based on wireless communication of claim 1, wherein the obtaining the first channel estimate and the second channel estimate according to the first observation signal and the second observation signal comprises:
multiplying the first observation signal and the second observation signal by a conjugate transpose or inverse of the first reference signal and the second reference signal respectively to obtain the first channel estimate and the second channel estimate.

3. The method for measuring the velocity based on wireless communication of claim 1, wherein the obtaining the first path gain corresponding to the first reference signal and the second path gain corresponding to the second reference signal based on the first channel estimate and the second channel estimate respectively comprises:
obtaining a first steering vector matrix corresponding to the first reference signal and a second steering vector matrix corresponding to the second reference signal respectively;
obtaining the first path gain based on the first steering vector matrix and the first channel estimate; and
obtaining the second path gain based on the second steering vector matrix and the second channel estimate.

4. The method for measuring the velocity based on wireless communication of claim 3, wherein the obtaining the first steering vector matrix corresponding to the first reference signal and the second steering vector matrix corresponding to the second reference signal comprises:
obtaining a first angle of arrival corresponding to the first reference signal and a second angle of arrival corresponding to the second reference signal through measurement, and obtaining the first steering vector matrix and the second steering vector matrix based on the first angle of arrival and the second angle of arrival respectively; or
obtaining the first steering vector matrix corresponding to the first reference signal and the second steering vector matrix corresponding to the second reference signal directly through measurement; or
extracting peak index through the first channel estimate to obtain a first position of the peak, obtaining a first beam arrival direction according to the first peak position, and obtaining the first steering vector matrix according to the first beam arrival direction; and extracting peak index through the second channel estimate to obtain a second position of the peak, obtaining a second beam arrival direction according to the second position, and obtaining the second steering vector matrix according to the second beam arrival direction; or
reporting, via the transmitting device, a position to a receiving end actively to obtain the first angle of arrival corresponding to the first reference signal and the second angle of arrival corresponding to the second reference signal; obtaining the first steering vector matrix and the second steering vector matrix respectively based on the first angle of arrival and the second angle of arrival; or
reporting, via the transmitting device, the first steering vector matrix corresponding to the first reference signal and the second steering vector matrix corresponding to the second reference signal to the receiving end actively.

5. The method for measuring the velocity based on wireless communication of claim 3, wherein the obtaining the first steering vector matrix corresponding to the first reference signal and the second steering vector matrix corresponding to the second reference signal respectively comprises:
configuring the first steering vector matrix as the second steering vector matrix; or
configuring the second steering vector matrix as the first steering vector matrix.

6. The method for measuring the velocity based on wireless communication of claim 1, wherein obtaining the path phase difference experienced by the first reference signal and the second reference signal according to the first path gain and the second path gain comprises:
calculating a cross-correlation function according to the first path gain and the second path gain, and extracting the path phase difference from the cross-correlation function.

7. The method for measuring the velocity based on wireless communication of claim 1, wherein the obtaining the first channel estimate and the second channel estimate according to the first observation signal and the second observation signal respectively comprises:
obtaining the first channel estimate and/or the second channel estimate according to any one of least square channel estimate, linear minimum mean square error channel estimate, singular value decomposition-based channel estimate, Fourier transform-based channel estimate, and artificial intelligence-based channel estimate.

8. The method for measuring the velocity based on wireless communication of claim 1, wherein the first reference signal and the second reference signal are signals whose transmission time and/or content is agreed upon by the transmitting device and the receiving device in advance;
the first reference signal and the second reference signal comprise any one or two of a demodulation reference signal, a sounding reference signal, a channel state information reference signal, a phase tracking reference signal, a synchronization signal, and a positioning reference signal; or
the first reference signal and the second reference signal comprise any one or two of a cyclic prefix signal, a broadcast signal, and a beacon signal; or
the first reference signal and the second reference signal comprise any one or two of a short training sequence signal and a long training sequence signal.

9. A system for measuring a velocity based on wireless communication, comprising:
a transmitting device and a receiving device communicated with the transmitting device;
wherein the transmitting device is configured to transmit a first reference signal and a second reference signal to the receiving device at an interval of a preset duration;
the receiving device is configured to obtain a first observation signal and a second observation signal, obtain a first channel estimate and a second channel estimate according to the first observation signal and the second observation signal respectively, obtain a first path gain corresponding to the first reference signal and a second path gain corresponding to the second reference signal based on the first channel estimate and the second channel estimate respectively, obtain a path phase difference experienced by the first reference signal and the second reference signal when transmitted to the receiving device according to the first path gain and the second path gain, obtain a Doppler shift based on the path phase difference and the preset duration, and obtain a moving velocity of the transmitting device relative to the receiving device based on the Doppler shift; and
wherein the first observation signal and the second observation signal are signals actually received by the receiving device when the first reference signal and the second reference signal transmitted to the receiving device via a channel.

10. A non-transitory computer-readable storage medium, wherein a computer program is stored in the computer-readable storage medium, and when the computer program is executed by a processor, the method for measuring the velocity based on wireless communication of claim 1 is performed by the processor.

11. A computer device, comprising a memory and a processor, wherein a computer program is stored in the memory, and when the computer program is executed by the processor, the method for measuring the velocity based on wireless communication of claim 1 is performed by the processor.
